(19) United States
(12) Patent Application Publication
(10) Pub. No.: US 2016/0188834 A1
(43) Pub. Date: Jun. 30, 2016

(54) DETERMINATION OF PATIENT-APPROPRIATE POST-ACUTE CARE SETTINGS

(71) Applicant: CERNER INNOVATION, INC., Kansas City, KS (US)

(72) Inventors: Cole A. Erdmann, Kansas City, MO (US); Tina Esposito, Downers Grove, IL (US); Jing Li, Rensselaer, NY (US); Bharat B. Sutariya, Parkville, MO (US)

(21) Appl. No.: 14/587,236

(22) Filed: Dec. 31, 2014

(51) Int. Cl. G06F 19/00

(52) U.S. Cl. CPC G06F 19/3431; G06F 19/322; G06F 19/345

(57) ABSTRACT

Methods, systems, and computer-readable media are provided for determining a post-acute care setting that is best suited to meet a patient's medical needs upon the patient being discharged from an acute-care facility. A set of propensity scores is generated for the patient using healthcare variables in the patient's electronic medical records. Each propensity score in the set corresponds to a particular post-acute care setting. The propensity scores may be used in association with a calculated risk of readmission for the patient to determine a post-acute care setting optimized to meet the patient's medical needs.

### BACKGROUND

Determining a post-acute care (PAC) setting best-suited to meet the medical needs of a patient being discharged from, for example, a hospital is important in not only reducing readmission rates for the patient but also improving the patient's overall quality of care. By properly aligning the patient with an appropriate PAC setting, moreover, a reduction in overall healthcare expenditures can also be achieved. For instance, it has been estimated that costs associated with readmission can be approximately 20% more than costs associated with the initial hospital stay.

Typical solutions to determining an appropriate PAC setting for a patient may rely on an assessment by the patient's clinician or care manager or on standardized decision-making flow charts that the clinician or care manager complete. Both of these approaches consume valuable time resources. As well, these approaches are generally subjective and/or binary (e.g., yes versus no) and are not driven by quantitative data. Lack of a data-driven approach to determining an appropriate PAC setting for patients may inhibit the health care industry from realizing increases in efficiency as evidenced by, for example, reductions in readmission rates.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, computer-storage media, computerized methods, and computing systems that determine an appropriate PAC setting for a patient being discharged from, for example, an acute-care setting. A set of propensity scores is generated for the patient using healthcare variables from the patient's electronic medical record (EMR). Each propensity score in the set corresponds to a particular PAC setting such as, for example, home, home health services, a skilled nursing facility, an inpatient rehabilitation facility, a long-term acute care facility, and the like. The patient's propensity scores may be used to determine the PAC setting most appropriate to meet the patient's medical needs as will be explained in greater depth below. Upon a determination being made, a PAC discharge recommendation may be generated and communicated to, for instance, the patient's clinician and/or care manager.

The systems and methods described above rely on quantitative data instead of subjective evaluations. Use of this type of data helps to reduce variability in decision making between the different clinicians and care managers involved in the patient's health care. Also, by using quantitative data to align the patient with the PAC setting best suited to meet the patient's medical needs, the risk of readmission for the patient may be reduced leading to health care savings and improved efficiencies for the discharging facility. In addition, use of this type of data to transition patients to appropriate PAC settings ultimately leads to an improved healthcare experience for the patient.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a block diagram showing an exemplary architecture for facilitating the determination of an appropriate level of post-acute care for a patient being discharged from a healthcare facility suitable to implement an embodiment of the present invention;

FIGS. 3-5 depict flow diagrams of exemplary methods of determining an appropriate level of post-acute care for a patient being discharged from a healthcare facility in accordance with embodiments of the present invention; and

FIG. 6 depicts a process-flow diagram of an exemplary process of determining an appropriate level of post-acute care for a patient being discharged from a healthcare facility in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Some patients being discharged from, for example, an acute care facility may require additional care to achieve optimal health. Transitioning these patients to appropriate PAC settings is important in optimizing the quality of care delivered to patients, reducing readmission rates, and decreasing the overall amount of healthcare expenditures. For instance, if a patient is discharged to a PAC setting that provides a lower level of care than that needed for the patient's medical needs, the patient's readmission risk is increased. Conversely, if the patient is transitioned to a PAC setting that provides a higher level of care than what is actually needed for the patient's medical needs, the patient's return to independence may be delayed and unnecessary healthcare costs may be incurred. As used throughout this disclosure, the concept of “transitioning a patient's care setting” can be defined as the movement of a patient from one setting of care (such as a hospital, skilled nursing facility, home, hospice, ambulatory clinic, home health, rehabilitation facility, and the like) to another setting of care. In general, each of these PAC settings provides a different level of care ranging from basic (e.g., home health) to intensive (e.g., long-term acute care facility). For example, an exemplary categorization of PAC settings based on level of care from basic to advanced may comprise home, home health, skilled nursing facility, inpatient acute rehabilitation facility, and long-term acute care facility.

Aspects described herein are directed to systems, methods, and computer-storage media for automatically and without human intervention determining an appropriate PAC setting for a patient being discharged from a healthcare facility such as, for example, a long-term acute care facility (e.g., a hospital). For each level of PAC, a propensity score is calculated for the patient using healthcare variables stored in the patient's EMR. Again for each PAC setting, the patient's propensity score is compared to a predetermined maximum propensity score and a predetermined minimum propensity score for that particular PAC setting. When the patient's propensity score is equal to or exceeds the predetermined maximum propensity score for the particular setting, a determination may be made that the patient be discharged to a PAC setting that provides a higher level of care than that of the particular setting being measured. On the other hand, if the patient's propensity score is less than or equal to the predetermined minimum propensity score for the particular setting, a determination may be made that the patient be discharged to a PAC setting that provides a level of care lower than the setting being measured.

If, however, the patient's propensity score has a value that falls between the predetermined minimum and maximum propensity scores for the PAC setting being measured, a readmission risk score is calculated for the patient using one or more known algorithms. The risk score is based on a comprehensive evaluation of the patient's current medical status. It is then determined whether discharging the patient to a PAC setting that provides an incrementally higher level of care than the setting being measured will reduce the patient's readmission risk by a predefined amount (e.g., more than 10%). If so, then a determination may be made that the patient be discharged to the PAC setting that provides the increased level of care. If not, then a determination may be made that the patient be discharged to the PAC setting being measured. After a final determination of a PAC setting has been made, a PAC discharge recommendation may be generated and communicated to a physician or care manager caring for the patient. Aspects thus described provide a data-driven, automated approach to aligning patients with PAC settings best-suited to meet the patients' medical needs and best-suited to reduce readmission risks.

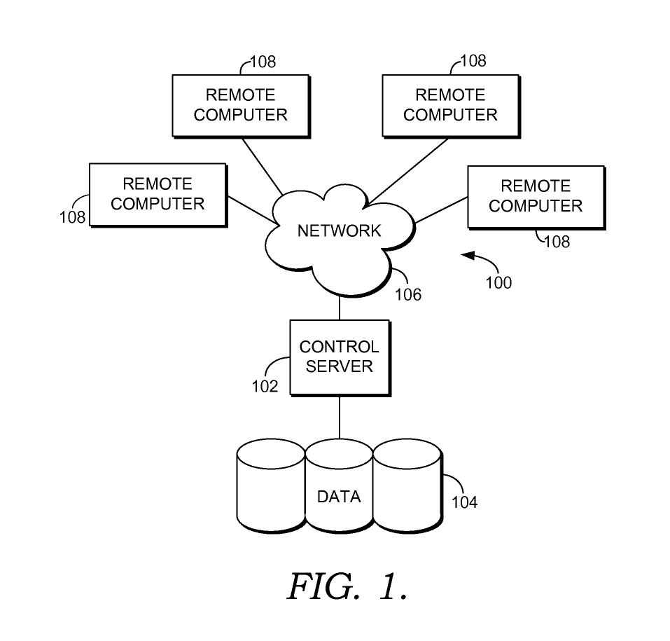

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as, removable and nonremovable media. By way of example, and not limitation, computer-readable media may comprise non-transitory computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

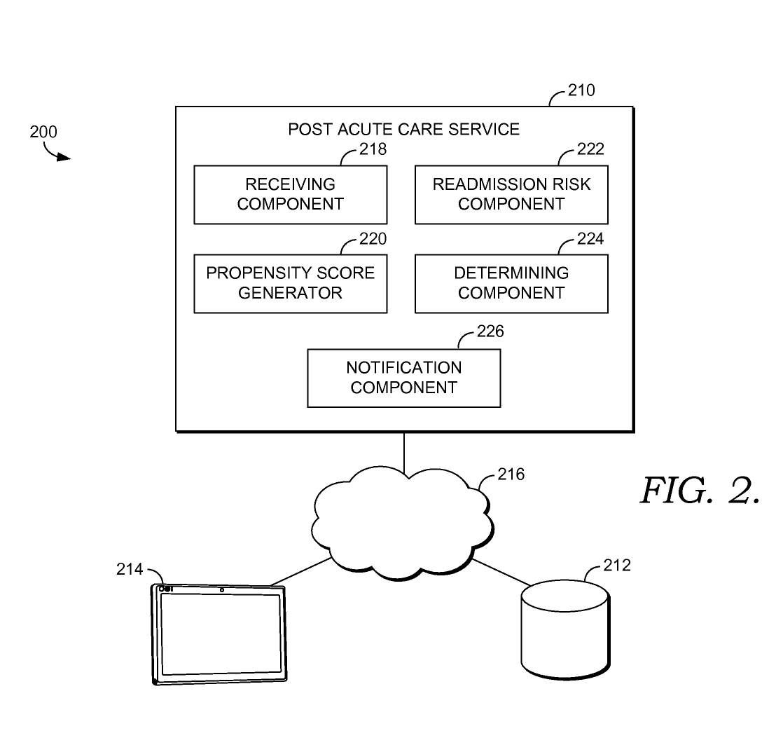

Turning now to FIG. 2, an exemplary computing system environment 200 is depicted suitable for use in implementing embodiments of the present invention. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a post-acute care service 210, a data store 212, and an end-user computing device 214 all in communication with one another via a network 216. The network 216 may include, without limitation, one or more local area networks (LANs) or wide area networks (WANs). The network 216 may be a secure network associated with a facility such as a healthcare facility. The secure network 216 may require that a user log in and be authenticated in order to send and/or receive information over the network 216.

In some embodiments, one or more of the illustrated components/modules may be implemented as stand-alone applications. In other embodiments, one or more of the illustrated components/modules may be integrated directly into the operating system of the post-acute care service 210. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the post-acute care service 210 might reside on a server, a cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 212 is configured to store information for use by, for example, the post-acute care service 210 and/or the end-user computing device 214. The information stored in association with the data store 212 is configured to be searchable for one or more items of information stored in association therewith. The information stored in association with the data store 212 may comprise general information used by the post-acute care service 210 and/or the end-user computing device 214.

In an exemplary aspect, the data store 212 may store electronic medical records (EMRs) of patients. EMRs may comprise electronic clinical documents such as images, clinical notes, orders, summaries, reports, analyses, or other types of electronic medical documentation relevant to a particular patient's condition and/or treatment. Electronic clinical documents contain various types of information relevant to the condition and/or treatment of a particular patient and can include information relating to, for example, patient identification information, images, alert history, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, and a host of other relevant clinical information.

The data store 212 may be further configured to store information such as predetermined minimum and maximum propensity scores for different PAC settings, propensity scores calculated for different patients, readmission risk scores for patients, and the like.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the post-acute care service 210, the end-user computing device 214, and/or any combination thereof.

As shown, the end-user computing device 214 includes a display screen. The display screen is configured to display information to the user of the end-user computing device 214, for instance, information relevant to communications initiated by and/or received by the end-user computing device 214, discharge recommendations regarding PAC settings, and/or the like. Embodiments are not intended to be limited to visual display but rather may also include audio presentation, combined audio/visual presentation, and the like. The end-user computing device 214 may be any type of display device suitable for presenting a user interface. Such computing devices may include, without limitation, a computer, such as, for example, any of the remote computers 108 described above with reference to FIG. 1. Other types of display devices may include tablet PCs, PDAs, mobile phones, smart phones, as well as conventional display devices such as televisions. Interaction with the graphical user interface may be via a touch pad, a pointing device, and/or gestures.

Components of the post-acute care service 210 may include a processing unit, internal system memory, and a suitable system bus for coupling various system components, including one or more data stores for storing information (e.g., files and metadata associated therewith). The post-acute care service 210 typically includes, or has access to, a variety of computer-readable media.

The computing system environment 200 is merely exemplary. While the post-acute care service 210 is illustrated as a single unit, it will be appreciated that the post-acute care service 210 is scalable. For example, the post-acute care service 210 may in actuality include a plurality of computing devices in communication with one another. Moreover, the data store 212, or portions thereof, may be included within, for instance, the post-acute care service 210 as a computer-storage medium. The single unit depictions are meant for clarity, not to limit the scope of embodiments in any form.

As shown in FIG. 2, the post-acute care service 210 comprises a receiving component 218, a propensity score generator 220, a readmission risk component 222, a determining component 224, and a notification component 226. In some embodiments, one or more of the components 218, 220, 222, 224, and 226 may be implemented as stand-alone applications. In other embodiments, one or more of the components 218, 220, 222, 224, and 226 may be integrated directly into the operating system of a computing device such as the remote computer 108 of FIG. 1. It will be understood that the components 218, 220, 222, 224, and 226 illustrated in FIG. 2 are exemplary in nature and in number and should not be construed as limiting. Any number of components may be employed to achieve the desired functionality within the scope of embodiments hereof.

The receiving component 218 is configured to receive user inputs, selections, commands, and/or requests. For instance, the receiving component 218 may be configured to receive an input request from a clinician or care manager for a discharge recommendation regarding a PAC setting for a particular patient. The receiving component 218 is further configured to receive/access healthcare variables stored in association with the patient's EMR that may then be used to generate propensity scores for the patient.

The propensity score generator 220 is configured to generate propensity scores for one or more patients using healthcare variables received/accessed by, for instance, the receiving component 218. For each patient, the propensity score generator 220 is configured to generate a set of propensity scores, where each score in the set corresponds to a particular PAC setting (e.g., home health, skilled nursing facility, inpatient rehabilitation facility, long-term acute care facility, and the like). To determine a patient's propensity score for a particular PAC setting, a defined set of healthcare variables is selected from the health information in the patient's EMR. The healthcare variables may comprise, for example, demographic information such as age, gender, race and insurance; social factors such as marital status, family support, and living conditions; amount of healthcare utilization such as the number of hospital visits in the past 6 or 12 months; and assessment information including an assessment of medical needs upon discharge. As well, the healthcare variables may comprise medications including past and present medications and medications upon discharge; disease conditions, procedures; lab results; and information from physical exams. The healthcare variable may include current variables as well as healthcare variables captured over the course of the patient's life.

In one aspect, the healthcare variables may be limited to a representative, predefined number between, for example, 90 to 100. Healthcare variables are included in the defined set if they are found to have statistical significance (P<0.05) in predicting the probability of obtaining PAC at any level in contrast to going home. This may be determined through a multivariate regression model. Moreover, the defined set of healthcare variables is compared to qualitative research results obtained from interviews, literature reviews, and the like, to check if any variables deemed important by these sources are not included in the defined set. Missing variables are then added to the set. For each PAC setting, the propensity score generator 220 is configured to assign a predetermined weight to each variable that reflects its importance to the particular PAC setting being measured. As a representative example, the need for mechanical ventilation may be weighted more heavily if the PAC setting is a long-term acute care facility, while it may be assigned a lesser weight if the PAC setting is a skilled nursing facility.

Once the variables have been selected and the weights assigned, the propensity score generator 220 is configured to perform logistic regression on the set of variables to derive a patient's propensity score for the particular PAC setting. The value of the patient's propensity score for a particular PAC setting reflects the propensity or probability of the patient being discharged to the particular PAC setting. The generation of a patient's propensity score for each PAC level may be done at substantially the same time a request is received by the receiving component 218 for a PAC discharge recommendation (i.e., in near real-time).

The propensity score generator 220 may be further configured to determine minimum and maximum propensity scores for each PAC setting. This process may occur in an “offline” setting (e.g., at the time the system is configured). In this aspect, the propensity score generator 220 utilizes the defined set of healthcare variables described above and performs propensity score matching on these variables to create retrospective case and control groups for each PAC level. The maximum and minimum propensity scores for each PAC setting are set using a 95% non-matching criteria. In other words, when 95% of the retrospective cases above a certain threshold do not match with any controls, that threshold is used as the maximum propensity score for that level. And when 95% of the retrospective controls below a certain threshold do not match with any cases, that threshold is used as the minimum propensity score for that level. Exemplary maximum and minimum propensity scores for a representative sample of PAC settings is set forth in Table 1 below:

TABLE 1

| | Maximum | Minimum |
|---|---|---|
| | Propensity | Propensity |
| Post-Acute Care Level | Score | Score |
| Home Health | 61 | 25 |
| Skilled Nursing Facility | 58 | 21 |
| Inpatient Rehabilitation Facility | 41 | 13 |
| Long-Term Acute Care Facility | 36 | 7 |

Once the set of propensity scores has been generated for the patient for each PAC setting, the determining component 224 compares the patient's propensity score for a particular PAC setting with the maximum and minimum propensity scores for that setting. This may be done in an iterative process starting at the lowest PAC setting (i.e., the setting that provides the lowest level of care such as home health) and progressing to the highest PAC setting (i.e., the setting that provides the highest level of care such as a long-term acute care facility). Alternatively, the comparison process may be carried out for a particular PAC setting of interest.

With respect to the comparison process, if the patient's propensity score is equal to or exceeds the maximum propensity score for the particular PAC setting, the determining component 224 determines that the patient should be evaluated for discharge to a PAC setting that provides a level of care incrementally greater than the measured setting. For instance, if the measured setting is home health, then the next level of care would be a skilled nursing facility. If the patient's propensity score is less than or equal to the minimum propensity score for the measured PAC setting, the determining component 224 determines that the patient should be discharged to a PAC setting that provides a level of care incrementally less than the measured setting. Using the example above, the level of PAC below home health would be the patient's own home.

Continuing, if it is determined that the patient should be evaluated for discharge to the PAC setting that provides a level of care incrementally greater than the measured setting, the patient's propensity score for the new setting is compared to the maximum and/or the minimum propensity scores for the new setting to determine if the patient should stay at the new setting or move up to a PAC setting that provides an incrementally even greater level of care. For example, assuming the new setting is a skilled nursing facility, if the patient's propensity score for this PAC setting is equal to or greater than the maximum propensity score for this setting, the determining component 224 determines that the patient should be evaluated for discharge to an inpatient rehabilitation facility. The process may then be repeated until a final determination regarding the PAC setting most appropriate for the patient is derived.

If, however, the determining component 224 determines that the patient's propensity score for a measured PAC setting lies between the maximum and minimum propensity scores for that setting, then the readmission risk component 222 is configured to determine a readmission risk score for the patient. A number of different known algorithms may be used to determine the patient's readmission risk score. These algorithms typically use information related to the patient's current medical status to determine the patient's risk of readmission within 30 days of being discharged.

The readmission risk component 222 is additionally configured to determine a percent reduction in the patient's risk score assuming that the patient is discharged to a PAC setting that provides a level of care incrementally greater than the setting currently being measured. For example, the readmission risk component 222 may determine that a patient's readmission risk score is reduced by 13% if the patient is discharged to a skilled nursing facility as compared to discharging the patient to home health.

Once the percent reduction in the patient's readmission risk score is determined by the readmission risk component 222, the determining component 224 determines if the reduction in the patient's readmission risk score is greater than or equal to a predefined amount such as 10%. If so, the determining component 224 determines that the patient should be discharged to the PAC setting that provides the level of care that is incrementally greater than the measured setting. If, however, the determining component 224 determines that the reduction in the patient's readmission risk score is below the predefined amount, the determining component 224 determines that the patient should be discharged to the measured setting. Using the example given above, if the measured PAC setting comprises home health and discharge to a skilled nursing facility would provide a 13% reduction in the patient's readmission risk score, the determining component 224 may determine that the patient should be discharged to a skilled nursing facility. But if discharge to the skilled nursing facility would only reduce the patient's readmission risk score by 3%, the determining component 224 determines that the patient should be discharged to home health.

Upon a final determination being made, the notification component 216 is configured to generate discharge recommendations regarding the PAC setting to which the patient should be discharged. The notification component 216 may be further configured to communicate these notifications to, for example, a physician or care manager involved in the patient's care.

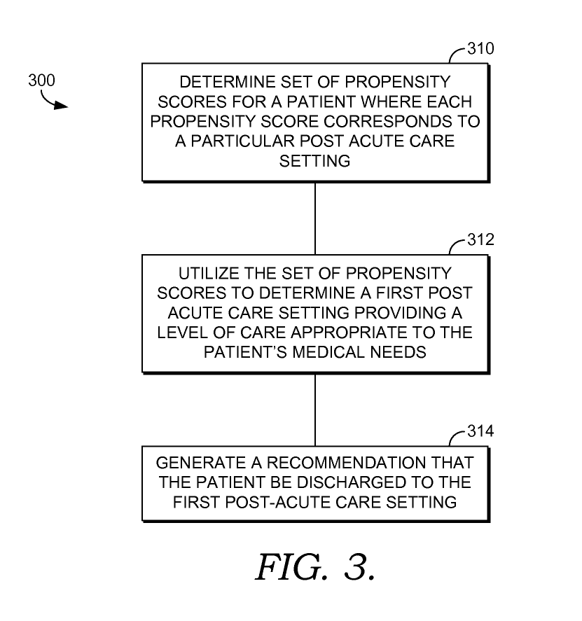

Turning now to FIG. 3, a flow diagram is depicted of an exemplary method 300 of determining a PAC setting best suited to meet a patient's medical needs upon discharge from a healthcare facility. In aspects, the healthcare facility may comprise an acute-care facility such as, for example, a hospital. The method 300 may be executed by a post-acute care service such as the post-acute care service 210 of FIG. 2. Further, the method 300 may be executed upon receiving a request for a PAC discharge recommendation from, for example, a physician or care manager associated with the patient.

At a step 310, a set of propensity scores is determined for the patient by, for instance, a propensity score generator such as the propensity score generator 220 of FIG. 2. Each propensity score in the set corresponds to a particular PAC setting such as, for example, home, home health, skilled nursing facility, inpatient rehabilitation facility, long-term acute care facility, and the like. The scores are generated by performing logistic regression on a defined set of healthcare variables associated with the patient and stored in the patient's EMR. The healthcare variables include current variables as well as historical healthcare variables and comprise demographic information, social factors, medications, labs results, procedure results, medical conditions, information from physical exams and assessments, and the like. Depending on the PAC setting, variables within the set are assigned a weight reflecting their importance to the particular PAC setting.

Once the patient's PAC scores have been generated, at a step 312, the scores are used to determine a PAC setting for the patient that is best-suited to meet the patient's medical needs. In other words, a PAC setting that provides a level of care that is commensurate with the patient's medical needs. This process may be carried out by a determining component such as the determining component 224 of FIG. 2.

At a step 314, a recommendation is generated that the patient be discharged to the determined PAC setting. This may be carried out by a notification component such as the notification component 226 of FIG. 2. The PAC discharge recommendation may then be communicated to the patient's physician or care manager. The method 300 is carried out automatically and without human intervention.

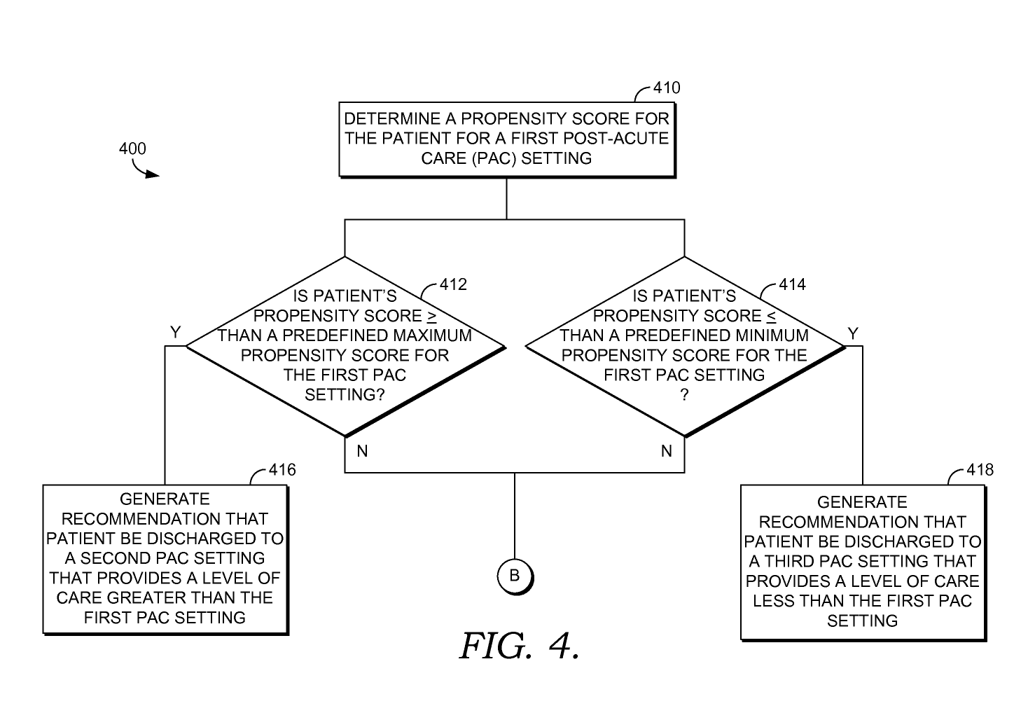

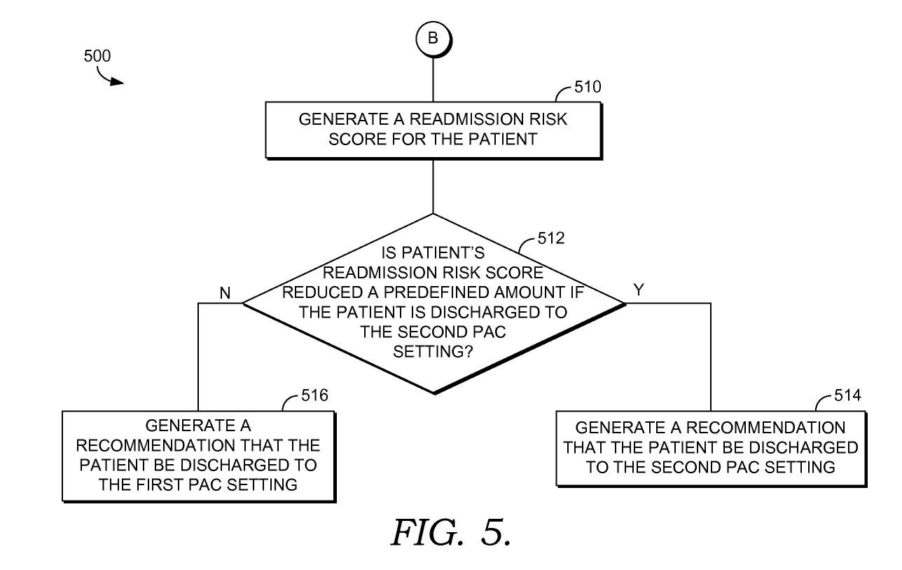

FIG. 4 depicts a flow diagram of an exemplary method 400 of determining an appropriate PAC setting for a patient being discharged from, for example, an acute-care facility. At a step 410, a propensity score for the patient for a first PAC setting is determined by a propensity score generator as set forth above in the method 300. At a step 412, a determining component such as the determining component 224 of FIG. 2 determines whether the patient's propensity score is greater than or equal to a maximum propensity score threshold for the first PAC setting. If, at the step 412, it is determined that the patient's propensity score is greater than the maximum propensity score for the first PAC setting, then, at a step 416, a recommendation is generated that the patient be discharged to a second PAC setting that provides a level of care greater than the first PAC setting. Moreover, at a step 414, the determining component further determines whether the patient's propensity score is less than or equal to a minimum propensity score threshold for the first PAC setting. If, at the step 414, it is determined that the patient's propensity score is less than the minimum propensity score for the first PAC setting, then, at a step 418, a recommendation is generated that the patient be discharged to a PAC setting that provides a level of care less than the first PAC setting. If, however, the patient's propensity score is less than the maximum propensity score for the first PAC level and if the patient's propensity score is greater than the minimum propensity score for the first PAC setting, then the method 400 continues as the exemplary method 500 depicted in FIG. 5.

Turning now to FIG. 5, a continuation of the method 400 is depicted as the method 500. When the patient's propensity score falls between the maximum and minimum propensity scores for the first PAC setting, then, at a step 510, a readmission risk score is generated for the patient. This may be carried out by a readmission risk component such as the readmission risk component 222 of FIG. 2. In aspects, known algorithms are utilized to determine the patient's readmission risk score. The score reflects the likelihood that the patient will be readmitted to an acute care facility within, for instance, 30 days of discharge and is based on an evaluation of the patient's current medical status.

At a step 512, a determination is made as to whether the patient's readmission risk score is reduced by a predefined amount if the patient is discharged to a second PAC setting that provides a level of care incrementally greater than the first PAC setting. For instance, if the first PAC setting is home health, then the PAC setting that provides a level of care incrementally greater than home health would by a skilled nursing facility. In an exemplary aspect, the predefined amount may be 10% or greater.

If a determination is made at the step 512 that the patient's readmission risk score will be reduced by greater than the predefined amount if the patient is discharged to the second PAC setting, then, at a step 516, a recommendation is generated that the patient be discharged to the second PAC setting. If however, it is determined that the patient's readmission risk score will not be reduced by the predefined amount if the patient is discharged to the second PAC setting, then, at a step 514, a recommendation is generated that the patient be discharged to the first PAC setting.

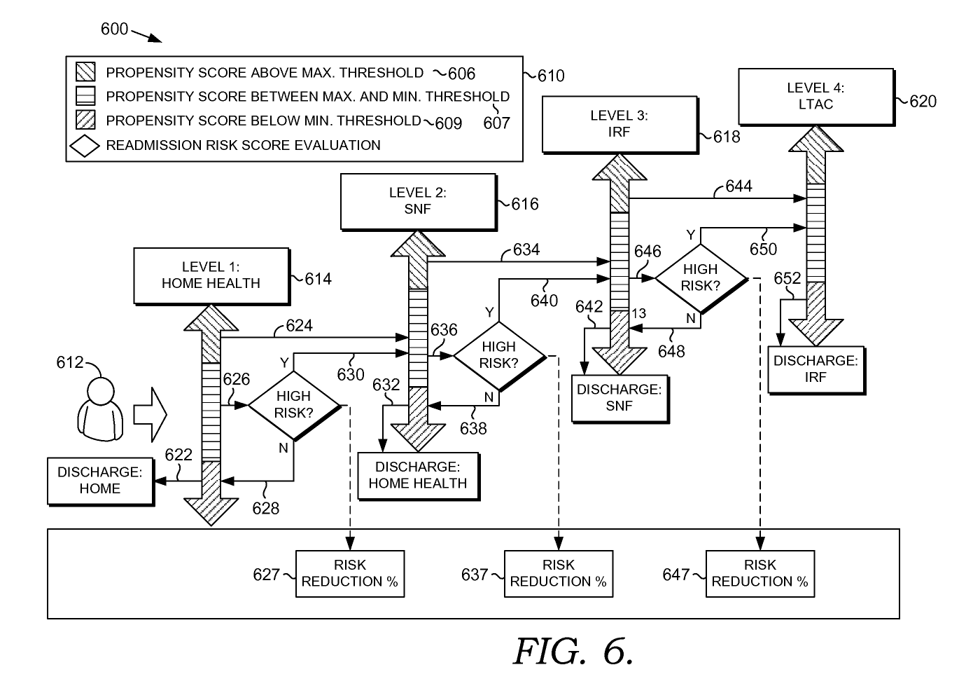

As explained earlier, the determination of which PAC setting is best-suited to meet the patient's medical needs may be carried out in an iterative process starting at the most basic level of care—home health. Alternatively, the process may not be iterative and a patient may be evaluated for one or more particular PAC settings. An exemplary evaluation process is depicted in FIG. 6 as a process flow diagram 600. The process starts with the patient 612 at the time of discharge from, for example, an acute care facility such as a hospital. Upon receiving a notice of discharge, a post-acute care service such as the post-acute care service 210 of FIG. 2 determines a set of propensity scores for the patient with a first propensity score associated with a level 1 home health PAC setting 614, a second propensity score associated with a level 2 skilled nursing facility PAC setting 616, a third propensity score associated with a level 3 inpatient rehabilitation facility PAC setting 618, and a fourth propensity score corresponding to a level 4 long-term acute care PAC setting 620. The PAC settings shown in FIG. 6 are exemplary only and it is contemplated that PAC settings in addition to or in place of those shown are within the scope herein. For instance, other PAC settings may comprise psychiatric hospitals, children hospitals, cancer hospitals, and the like.

Beginning with, for instance, the PAC setting of home health 614, the patient's propensity score for this setting 614 is compared to a predetermined maximum propensity score for the setting 614 as indicated by the hash marks 606 shown in the key 610. The patient's propensity score is also compared to a predetermined minimum propensity score for the setting 614 as indicated by the hash mark 609 shown in the key 610. If the patient's propensity score is above the maximum propensity score for the setting 614, then at step 624, it is determined that the patient 612 should be evaluated for the second PAC setting 616 (e.g., skilled nursing facility (SNF)). If the patient's propensity score is below the minimum propensity score for the setting 614, then it is determined that the patient should be discharged to a home PAC setting as indicated by step 622.

If, however, the patient's propensity score for the PAC setting 614 falls between the maximum and minimum propensity scores for the setting 614 as indicated by the hash marks 607 in the key 610, then at step 626 a readmission risk score is calculated for the patient, and at step 627 a determination is made as to the percent reduction in the patient's risk score if the patient is discharged to the PAC setting 616. If the percent reduction is above a predefined threshold such as, for example, 10%, then at step 630 it is determined that the patient 612 should be discharged to the PAC setting 616. But if the percent reduction is below the predefined threshold, then at step 628 it is determined that the patient should be discharged to the PAC setting 614 (e.g., home health).

A similar process is carried out for the PAC setting 616. For instance, the patient's propensity score for the setting 616 is compared to predetermined maximum and minimum propensity scores for this setting 616 as indicated by the hash marks 606 and 609. If the patient's propensity score is greater than or equal to the predetermined maximum propensity score for the setting 616, then at step 634 it is determined that the patient 612 should be evaluated for the PAC setting 618 (e.g., inpatient rehabilitation facility (IRF)). But if the patient's propensity score for the setting 616 is below the predetermined minimum propensity score for the setting 616, then it is determined at step 632 that the patient 612 should be discharged to the PAC setting 614.

If the patient's propensity score for the PAC setting 616 is between the maximum and minimum propensity scores for the setting 616 as indicated by the hash marks 607, then at step 636 the patient's readmission risk score is calculated (if not already done so), and at step 637 it is determined whether the risk score would be reduced by a predefined amount if the patient is discharged to the PAC setting 618. The predefined amount of risk reduction for the transition from the PAC setting 616 to 618 may be the same or different as the predefined amount of risk reduction for the transition from the PAC setting 614 to the setting 616. If the patient's readmission risk score is reduced by the predefined amount, then at step 640 it is determined that the patient 612 should be discharged to the PAC setting 618. If the patient's readmission risk score is not reduced by the predefined amount, then at step 638 it is determined that the patient 612 should be discharged to the PAC setting 616.

Continuing, for the PAC setting 618, the patient's propensity score for this setting is compared to the maximum and minimum propensity scores for the setting 618. If the patient's propensity score is greater than or equal to the maximum propensity score, it is determined at step 644 that the patient 612 should be discharged to the PAC setting 620. In this example, the setting 620 comprises long-term acute care which, theoretically, is the highest level of care available. If the patient's propensity score for the setting 618 is equal to or less than the minimum propensity score for the setting 618, it is determined at step 642 that the patient 612 should be discharged to the PAC setting 616.

If the patient's propensity score for the setting 618 lies between the minimum and maximum propensity scores for the setting 618, then at step 646 the patient's readmission risk score is calculated (if not already done so), and at step 647 it is determined whether the risk score is reduced by a predefined amount upon the patient being discharged to the PAC setting 620. The predefined amount of risk reduction determined at the step 647 may be the same or different than the amount determined at step 627 and/or step 637. If the patient's readmission score is reduced by the predefined amount, then at step 650 it is determined that the patient should be discharged to the PAC setting 620. But if the patient's readmission risk score is not reduced by the predefined amount, then at step 648 it is determined that the patient 612 should be discharged to the PAC setting 618.

In aspects, the patient 612 may also be evaluated for the PAC setting 620. For example, the patient's propensity score for this PAC setting may be determined to be less than the minimum propensity score for the setting 620. If so, then at step 652, it may be determined that the patient 612 be discharged to the PAC setting 618. In those situations where there are additional PAC settings beyond the PAC setting 620, a similar evaluation as to that provided above may be carried out to determine whether the PAC setting 620 is best-suited to meet the patient's medical needs or if a different type of setting may be more appropriate such as, for example, a psychiatric hospital. Any and all such aspects, and any variation thereof, are contemplated as being within the scope herein.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. One or more computer-storage media having computer-executable instructions embodied thereon that, when executed by a computing device, perform a method of determining an appropriate post-acute care (PAC) setting for a patient being discharged from a healthcare facility, the method comprising:
determining a set of propensity scores for the patient, each propensity score in the set of propensity scores corresponding to a particular PAC setting that provides a particular level of care;
utilizing the set of propensity scores to determine a first PAC setting providing a level of care appropriate for the patient's medical needs; and
generating a recommendation that the patient be discharged to the first PAC setting.

2. The media of claim 1, wherein the set of propensity scores for the patient is determined based on healthcare variables stored in association with the patient's electronic medical record.

3. The media of claim 2, wherein the healthcare variables comprise current healthcare variables and historical healthcare variables.

4. The media of claim 3, wherein the healthcare variables comprise at least demographic data, social factors, medications, health care utilization information, procedures, lab results, medical conditions, information from physical exams, and clinical assessments.

5. The media of claim 4, wherein the healthcare variables are weighted differently for each particular PAC setting.

6. The media of claim 1, wherein the first PAC setting comprises one of:
home health, skilled nursing facility, or long-term acute care.

7. The media of claim 6, wherein the first PAC setting further comprises one of: inpatient rehabilitation facility, hospice, psychiatric facility, cancer facility, or a children's hospital.

8. The media of claim 1, wherein utilizing the set of propensity scores to determine that the first PAC setting provides the level of care appropriate for the patient's medical needs comprises:
selecting a first propensity score in the set of propensity scores, the first propensity score corresponding to a second PAC setting that provides a level of care incrementally greater than the first PAC setting;
comparing the first propensity score to a predetermined minimum propensity score and a predetermined maximum propensity score for the second PAC setting;
determining that the first propensity score is less than or equal to the predetermined minimum propensity score for the second PAC setting; and
based on determining that the first propensity score is less than or equal to the predetermined minimum propensity score for the second PAC setting, determining that the first PAC setting provides the level of care appropriate for the patient's medical needs.

9. The media of claim 1, wherein utilizing the set of propensity scores to determine that the first PAC setting provides the level of care appropriate for the patient's medical needs comprises:
selecting a first propensity score in the set of propensity scores, the first propensity score corresponding to the first PAC setting;
comparing the first propensity score to a predetermined minimum propensity score and a predetermined maximum propensity score for the first PAC setting;
determining that the first propensity score has a value between the predetermined minimum propensity score and the predetermined maximum propensity score for the first PAC setting;
determining a readmission risk score for the patient;
determining that the patient's readmission risk score is not reduced by a predefined amount if the patient is discharged to a second PAC setting that provides a level of care greater than the first PAC setting; and
based on determining that the patient's readmission risk score is not reduced by the predefined amount if the patient is discharged to a second PAC setting, determining that the first PAC setting provides the level of care appropriate for the patient's medical needs.

10. The media of claim 1, further comprising communicating the notification to a care manager assigned to the patient.

11. A computerized method carried out by at least one server having at least one processor for determining an appropriate post-acute care (PAC) setting for a patient being discharged from a healthcare facility, the method comprising:
determining, using the at least one processor, a propensity score for the patient for a first PAC setting; and
comparing the patient's propensity score to a predefined minimum propensity score and a predefined maximum propensity score for the first PAC setting, wherein:
when the patient's propensity score is above the predefined maximum propensity score for the first PAC setting, generating a recommendation that the patient be discharged to a second PAC setting that provides a level of care greater than the first PAC setting; and
when the patient's propensity score is below the predefined minimum propensity score for the first PAC setting, generating a recommendation that that patient be discharged to a third PAC setting that provides a level of care less than the first PAC setting.

12. The method of claim 11, wherein the patient's healthcare variables are used to determine the patient's propensity score.

13. The method of claim 12, wherein the patient's healthcare variables are stored in association with the patient's electronic medical record (EMR).

14. The method of claim 11, wherein the first PAC setting comprises one of home health, skilled nursing facility, inpatient rehabilitation facility, or long-term acute care facility.

15. The method of claim 11, wherein when the patient's propensity score has a value between the predefined minimum propensity score and the predefined maximum propensity score for the first PAC setting, determining a readmission risk score for the patient and utilizing the patient's readmission risk score to determine whether the patient should be discharged to the first PAC setting or the second PAC setting.

16. The method of claim 15, wherein utilizing the patient's readmission risk score to determine whether the patient should be discharged to the first PAC setting or the second PAC setting comprises:
determining whether the patient's readmission risk score is reduced by a predefined amount if the patient is discharged to the second PAC setting, wherein:
when the patient's readmission risk score is reduced by the predefined amount, generating a recommendation to discharge the patient to the second PAC setting, and
when the patient's readmission risk scores is not reduced by the predefined amount, generating a recommendation to discharge the patient to the first PAC setting.

17. A system for determining an appropriate post-acute care (PAC) setting for a patient being discharged from a healthcare facility, the system comprising:
a computing device having one or more processors and one or more computer-storage media; and
a data store coupled with the computing device,
wherein the computing device:
determines a first propensity score for the patient for a first PAC setting providing a first level of care;
compares the first propensity score to a predetermined minimum propensity score and a predetermined maximum propensity score for the first PAC setting;
generates a first recommendation that the patient be discharged to a second PAC setting that provides a second level of care greater than the first level of care when the patient's propensity score is greater than the predetermined maximum propensity score; and
generates a second recommendation that the patient be discharged to a third PAC setting that provides a third level of care less than the first level of care when the patient's propensity score is less than the predetermined minimum propensity score for the first PAC setting.

18. The system of claim 17, wherein the first PAC setting comprises one of:
home health, skilled nursing facility, inpatient acute rehabilitation facility, or long-term acute care facility.

19. The system of claim 17, wherein the predetermined minimum propensity score and the predetermined maximum propensity score for the first PAC setting are determined using propensity score matching.

20. The system of claim 17, wherein either the first recommendation or the second recommendation is communicated to a care manager associated with the patient.
